(19) United States
(12) Patent Application Publication
(10) Pub. No.: US 2018/0297734 A1
(43) Pub. Date: Oct. 18, 2018

(54) AUTOMATION FOR PLASTIC DISC

(71) Applicant: AVERY DENNISON CORPORATION, Glendale, CA (US)

(72) Inventor: William J. COOPER, Shrewsbury, MA (US)

(21) Appl. No.: 15/487,711

(22) Filed: Apr. 14, 2017

(51) Int. Cl. B65C 7/00; G09F 3/12

(52) U.S. Cl. CPC B65C 7/003; G09F 3/12

(57) ABSTRACT

An apparatus for reinforcing stapling connections created by an elastic stapling apparatus with a plurality of individual reinforcing elements. The apparatus constructs and deploys the plurality of individual reinforcing elements simultaneously with the elastic stapling apparatus generating a plurality of plastic fasteners. The apparatus manufactures the plurality of individual reinforcing elements from a pair of oppositely disposed rolls of reinforcing stock material. The individual reinforcing elements provide additional structural integrity to articles that are deformable in construction.

### BACKGROUND

The present invention relates generally to an apparatus for manufacturing and deploying reinforcing elements such as plastic discs in conjunction with a fastening system. More particularly, the present disclosure relates to an apparatus for use in combination with an elastic stapling apparatus for reinforcing the stapling connection point on packaging material while securing products to the packaging material with the elastic stapling apparatus.

Elastic or plastic fasteners are commonly used to secure a variety of irregularly shaped products to packaging materials such as cardboard backing. The elastic fasteners are typically H-shaped in configuration, with two shortened parallel crossbars, or T-bars, being interconnected at their approximate midpoints by a thin, flexible filament that extends orthogonally there between. The elastic fasteners, or staples, are typically individually generated from a supply of ladder stock or from separate supplies of filament and T-bar stocks. The elastic fasteners may be formed from ladder stock, such as that presently manufactured and sold by Avery Dennison Corporation of Pasadena, Calif. under PLASTIC STAPLE® and ELASTIC STAPLE′ lines of plastic fasteners.

The elastic fasteners may be generated by a plastic fastener device, such as an IndES® 11601 (IndES) manufactured and sold by Avery Dennison Corporation of Pasadena, Calif. These systems are designed to securely fasten items such as housewares, toys and hardware to backing cards typically manufactured from cardboard. The pneumatically driven IndES unit can operate as a standalone unit or integrated into an automatic packaging line. The plastic fastener devices secure the products to packaging by threading a pair of hollow needles loaded with fastener stock and puncturing the backing card on either side of the product to be secured. An individual elastic fastener is left behind securing the product with a filament to the backing with a pair of T-bars. The pair of T-bars engages the backside of the backing to attach the product to the packaging material.

When each needle penetrates the backing, a hole in the backing material is created. The T-bar portion of the fastener springs perpendicularly to the filament to engage the backing and keep the fastener in place. Heavier products or thin backing material can create a strain on the connection point between the fastener and the backing. This strain can lead to a tear or unwanted expansion of the insertion hole, leading to a loss of the connection. Once a connection is compromised, the product is no longer secured to the packaging.

Thus, there exists a need for a way to reinforce the connection point between the elastic fastener and the backing material. The present invention discloses an apparatus for supplying and deploying reinforcement to this vulnerable connection point. The apparatus generates and installs a plurality of reinforcing elements in conjunction with an elastic stapling device. Elastic fasteners are generated and deployed by the elastic stapling device simultaneously with the generation and deployment of reinforcing elements by the present invention in a single operation.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an apparatus for manufacturing and positioning a plurality of individual reinforcing elements for use with a plurality of elastic fasteners. The apparatus comprises a base plate and a pair of modules mounted to the base plate. The pair of modules feed a pair of rolls of reinforcing stock through the apparatus and cut off the individual reinforcing elements. The individual reinforcing elements are deployed and positioned by the pair of modules to align with the plurality of elastic fasteners generated and deployed by an elastic stapling apparatus, thereby reinforcing a connection point where the fasteners attach to a backing or packaging material.

In a preferred embodiment, each of the pair of modules comprises a pneumatic element, a linkage drive block, a cutting block, and a cam element. The linkage drive block is engaged by the pneumatic element, and is moveably connected to the cutting block by the cam element. Each of the pair of modules further comprises a strip feed block for feeding one of the pair of rolls of reinforcing stock through the apparatus. Each of the pair of modules further comprises a module cover element for resisting backward movement of one of the pair of rolls of reinforcing stock as it moves through the apparatus, and a cutting element for cutting off the plurality of reinforcing elements once positioned to reinforce the plurality of elastic fasteners.

The pneumatic element is extended, thereby pushing the linkage drive block forward along a guide slot in the cam element. This movement forces the cutting block downward allowing a portion of the reinforcing stock to extend over the cutting block. Once positioned, the pneumatic element is retracted pulling the linkage drive block back forcing the cutting block upward. As the cutting block is pushed upward, the supply of reinforcing stock is forced against the cutting element, thereby severing off an individual reinforcing element.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of an apparatus for dispensing a plurality of individual reinforcing elements from a supply of reinforcing stock for use in conjunction with an elastic stapling apparatus in accordance with the disclosed architecture.

FIG. 2 illustrates a side perspective view of the apparatus in accordance with the disclosed architecture.

FIG. 3 illustrates a perspective view of a supply of reinforcing stock and a plurality of individual reinforcing elements for use with the apparatus in accordance with the disclosed architecture.

FIG. 4 illustrates a side perspective view of a pair of rolls of the reinforcing stock material fed into a pair of modules attached to a base plate of the apparatus in accordance with the disclosed architecture.

FIG. 5 illustrates a perspective view of one of the pair of modules in accordance with the disclosed architecture.

FIG. 6 illustrates a side perspective view of a strip feed block of one of the pair of modules in accordance with the disclosed architecture.

FIG. 6A illustrates a side perspective view of a stock positioning element of the strip feed block in accordance with the disclosed architecture.

FIG. 7 illustrates a perspective view of a top cover block of one of the pair of modules in accordance with the disclosed architecture.

FIG. 8 illustrates a side view of a module cover element of one of the pair of modules in accordance with the disclosed architecture.

FIG. 8A illustrates a side view of a detent component of the module cover element in accordance with the disclosed architecture.

FIG. 9 illustrates a side view a cutting block of one of the pair of modules in a cut position in accordance with the disclosed architecture.

FIG. 10 illustrates a side perspective view of the pair of modules adjustably attached to the base plate in accordance with the disclosed architecture.

FIG. 11 illustrates an overhead view of a center slot in a top plate of the module cover element in accordance with the disclosed architecture.

FIG. 12 illustrates an end cut away view of one of the pair of modules in accordance with the disclosed architecture.

FIG. 13 illustrates a partially exploded view of the supply of reinforcing stock being loaded onto one of a pair of stock engaging components of the apparatus in accordance with the disclosed architecture.

FIG. 14 illustrates a side perspective view of a strip of the reinforcing stock material being fed into one of the pair of modules in accordance with the disclosed architecture.

FIG. 14A illustrates a cut away view of the strip of the reinforcing stock material being fed into one of the pair of modules in accordance with the disclosed architecture

FIG. 15A illustrates a perspective view of one of the plurality of modules in a load position in accordance with the disclosed architecture.

FIG. 15B illustrates a perspective view of one of the plurality of modules in a feed position in accordance with the disclosed architecture.

FIG. 15C illustrates a perspective view of one of the plurality of modules in a cut position in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

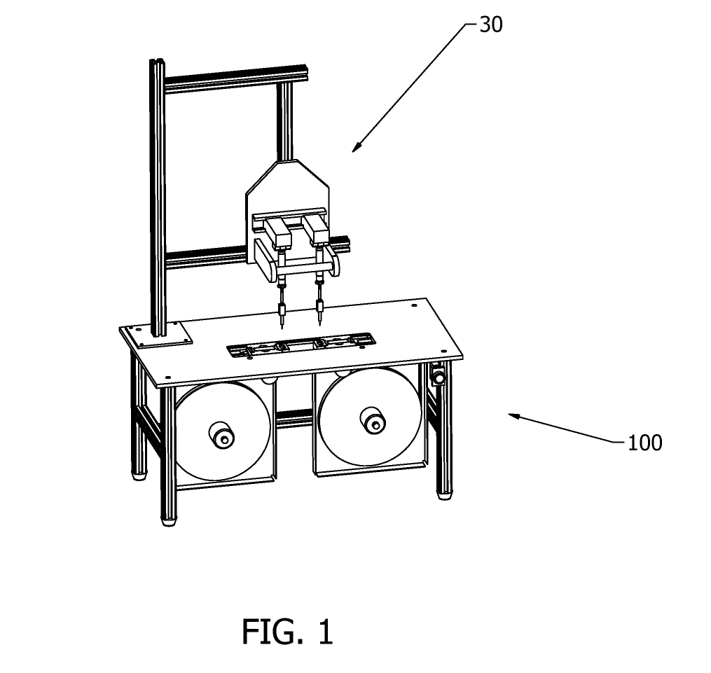

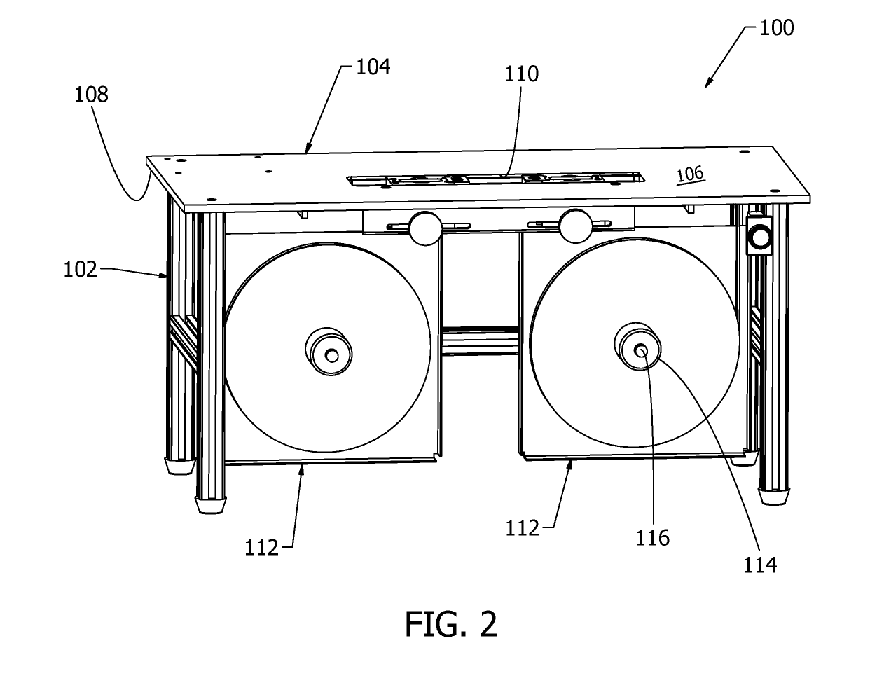

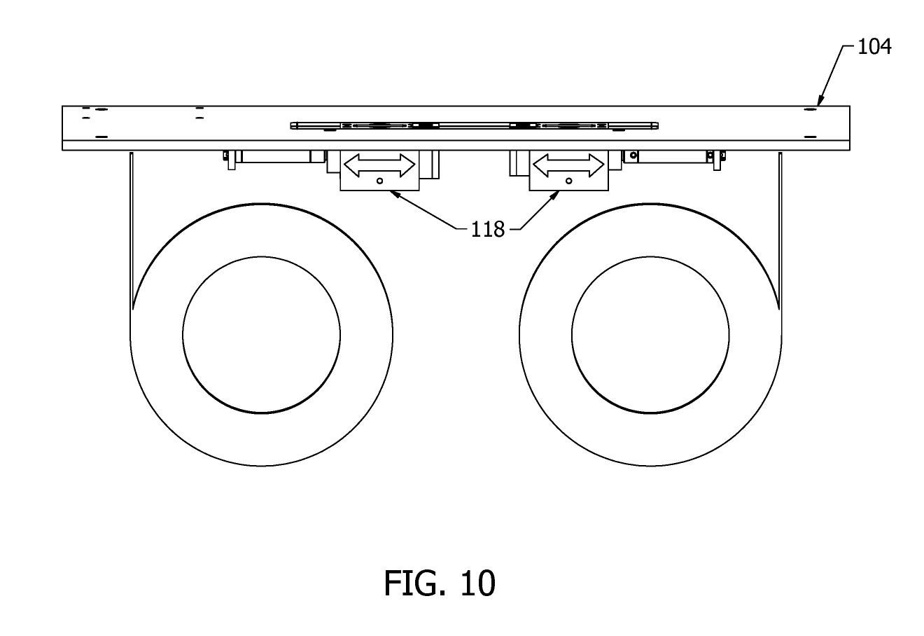

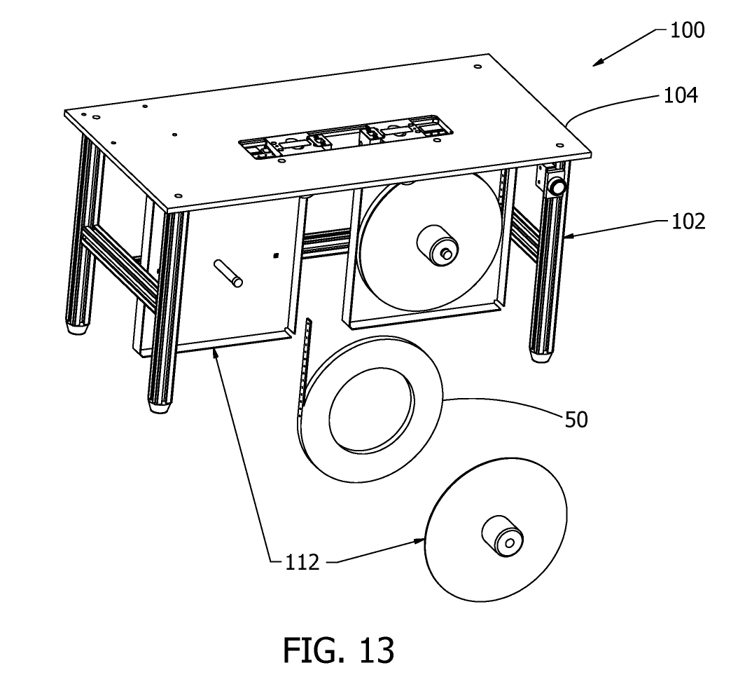

Referring initially to the drawings, FIGS. 1-15 illustrate an apparatus 100 for generating a plurality of individual reinforcing elements 60 out of a supply of reinforcing stock 50 in accordance with the present invention. As illustrated in FIGS. 1 and 2, the apparatus 100 comprises a frame 102 and a base plate 104. The base plate 104 comprises a top side 106, a bottom side 108, and is adapted to support an elastic stapling apparatus 30 and the supply of reinforcing stock 50. One example of the elastic stapling apparatus 30 useable with the apparatus 100 is an IndES industrial elastic stapling system, as described supra. The IndES uses a pair of needles approximately 3/16 inches in diameter to fasten products to packaging material, such as cardboard backing, using an elastic staple. The IndES machine's needles puncture the packaging material and eject staple ends through the puncture holes. The staple ends flex into position to fix the elastic staple in place, thereby securing the product to the packaging material.

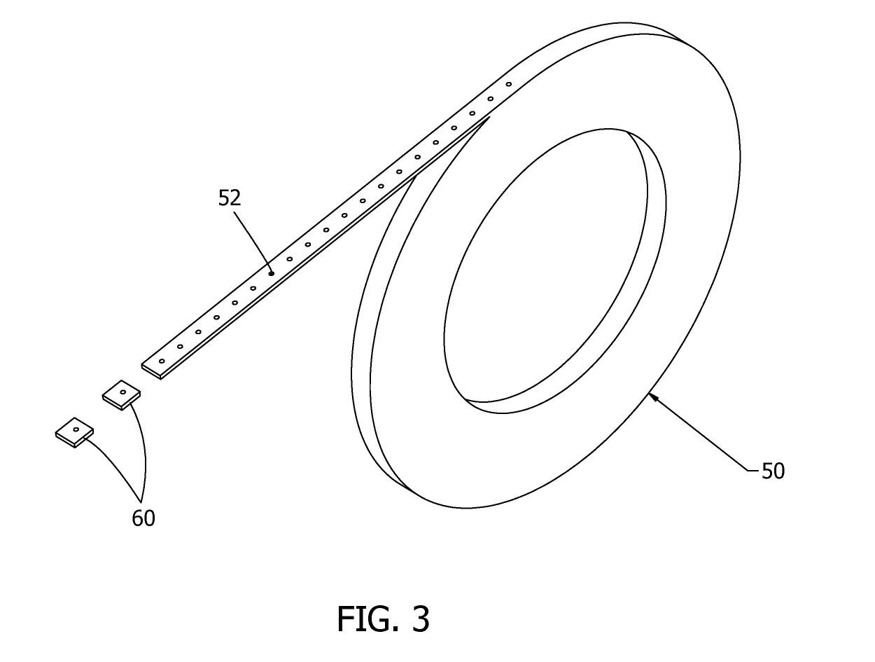

The apparatus 100 may be used to manufacture the plurality of individual reinforcing elements 60 to reinforce a plastic or elastic fastener in a fastener assembly as described in commonly assigned U.S. 2016/0039555A1, which is incorporated herein by reference. As illustrated in FIG. 3, the plurality of individual reinforcing elements 60 are preferably formed as unitary, solid discs, which are constructed out of stiff plastic materials that resist deformation, such as but not limited to, polypropylene, polyethylene, polyethylene terephthalate. The plurality of individual reinforcing elements 60 are represented herein as generally square-shaped tabs. However, this is not meant as a limitation, as the plurality of individual reinforcing elements 60 may be constructed in any alternate configuration, size, or shape as to correspond to the dimensions necessary to reinforce the plastic fastener used.

The supply of reinforcing stock 50 for use with the apparatus 100 is typically configured as a pair of rolls of reinforcing stock material. In one embodiment, each of the pair of rolls of reinforcing material is formed from a strip of the stiff plastic material 56 approximately ½ inches in width with a plurality of holes 52 approximately centrally disposed along a centerline at approximately ½ inch intervals. The diameter of each of the plurality of holes 52 is sized slightly larger than the diameter of the needle of the elastic stapling apparatus 30. The pair of rolls of reinforcing stock material are loaded on the apparatus 100, as illustrated in FIGS. 2, 4 and 13, which cuts each strip of the stiff plastic material 56 into approximately ½ inch square individual reinforcing elements 60 with a center hole 52. While specific dimensions have been described with respect to this particular embodiment, the dimensions are not meant as a limitation as the dimensions may be customized for use with any sized plastic fastener as desired.

The apparatus 100 further comprises a pair of stock engaging components 112, each comprising a reel 114 attached to a shaft 116. Each of the pair of stock engaging components 112 are mounted to the frame 102 underneath the base plate 104. The frame 102 serves as a support or foundation for the base 104. The base 104 is generally rectangular in configuration and further comprises a centrally disposed opening 110. Each roll of reinforcing stock material is loaded onto one of the reels 114, which rotates along the shaft 116 feeding each strip of the reinforcing stock material 56 off of the roll of reinforcing stock material into the apparatus 100.

With the plurality of individual reinforcing elements 60 positioned against or near a back side of the packaging, the elastic stapling apparatus 30 punches holes in the packaging material in-line with the plurality of individual reinforcing elements 60, dispenses a plastic fasteners through the needles, and secures each plastic fastener to a reinforced connection point formed by the packaging and one of individual reinforcing elements 60. As such, the plurality of individual reinforcing elements 60 provides structural stability to the packaging material.

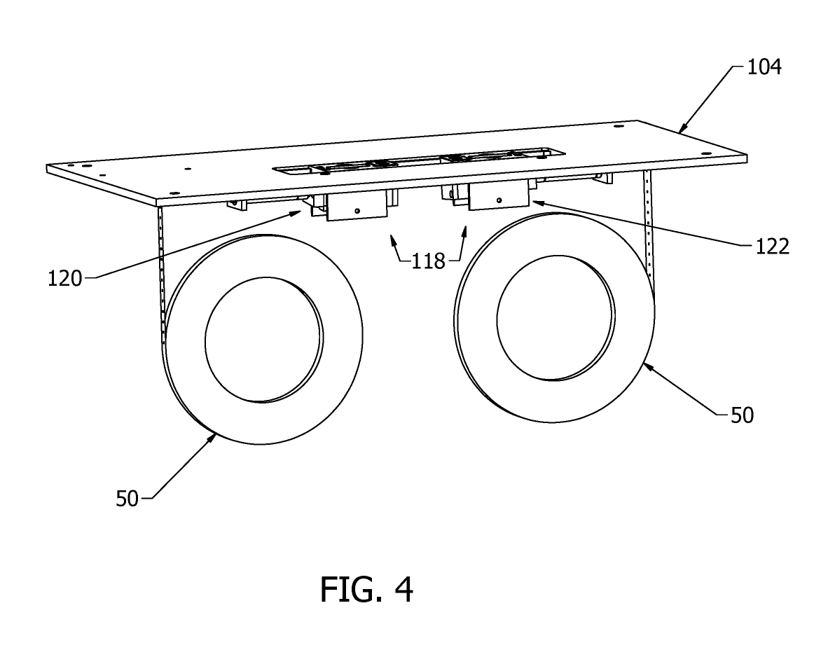

As illustrated in FIGS. 4, 5, and 10 the apparatus 100 further comprises a pair of modules 118 movably mounted to the base plate 104 within the centrally disposed opening 110 to align with the elastic stapling apparatus 30. A first 120 and a second 122 of the pair of modules 118 are identically configured, adjustable in position within the centrally disposed opening 110, and movably mounted in opposing directions. The pair of modules 118 are adapted to receive the supply of reinforcing stock 50, sever the supply of reinforcing stock 50 into the plurality of individual reinforcing elements 60, and to deploy the plurality of individual reinforcing elements 60 in conjunction with the elastic staples to reinforce the plurality of stapling connections.

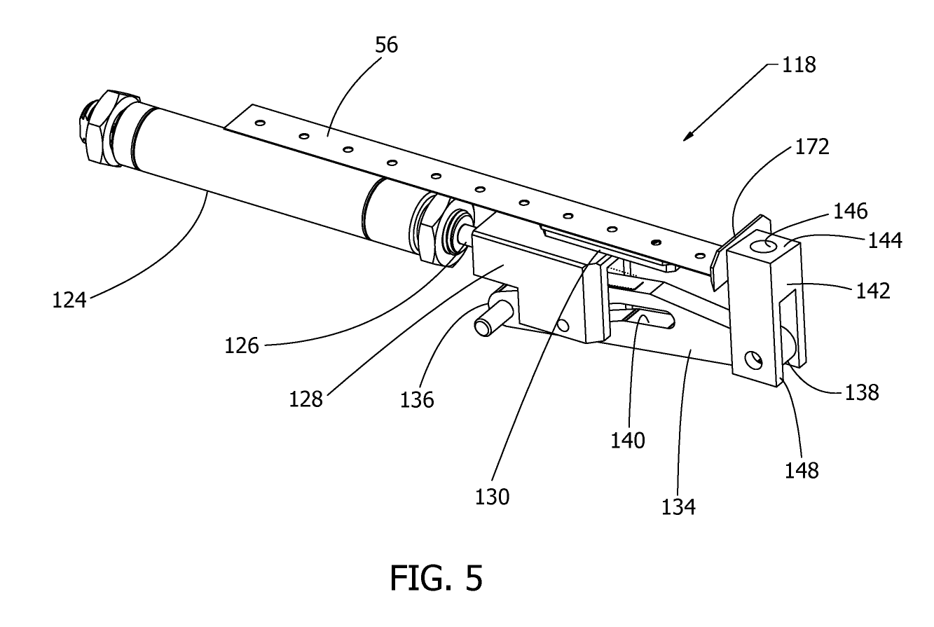

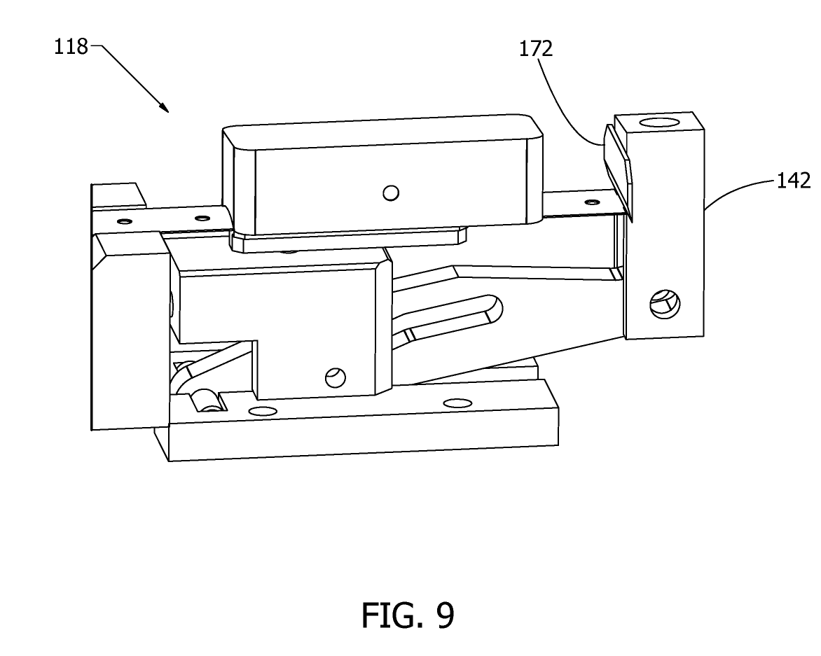

As illustrated in FIGS. 5 and 9, each of the pair of modules 118 comprises a pneumatic element 124, a linkage drive block 128, a cam element 134, and a cutting block 142. The pneumatic element 124 is typically an air cylinder that moves a piston rod 126. The piston rod 126 is connected to one end of the linkage drive block 128. The cam element 134 comprises a first end 136 fixed to the module 118, a second end 138 movably connected to the cutting block 142, and a guide slot 140. The other end of the linkage drive block 128 is movably retained within the guide slot 140 of the cam element 136. As such, the cam element 142 movably connects the linkage drive block 128 and the cutting block 142. The guide slot 140 is generally angularly configured so as to move the cutting block 142 up and down as the piston rod 126 is pushed or retracted by the pneumatic element 124.

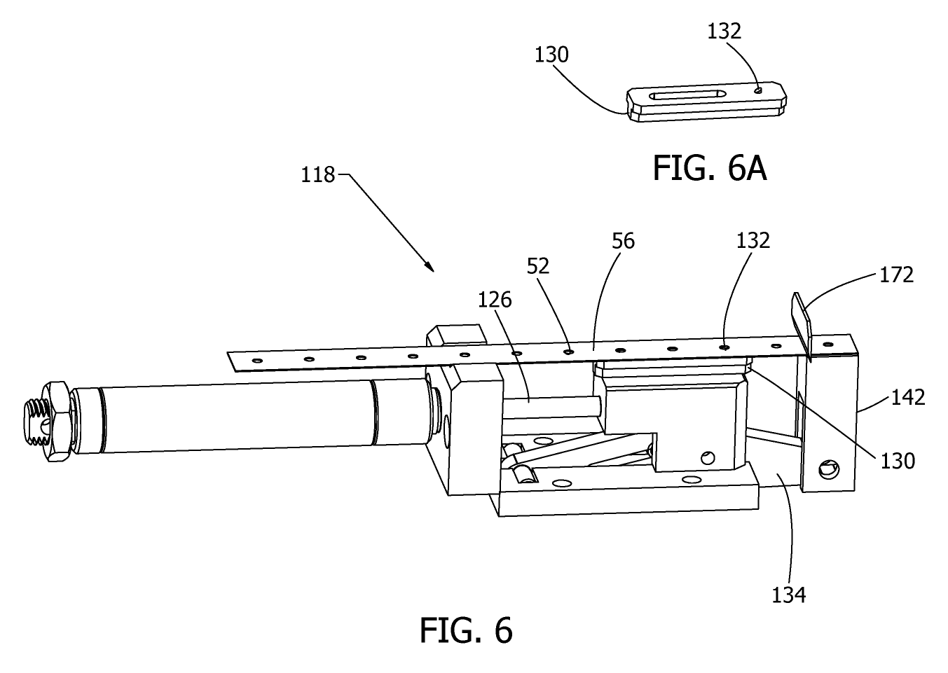

As illustrated in FIGS. 6 and 6A, each module 118 further comprises a strip feed block 130 comprising a stock positioning element 132. The strip feed block 130 is mounted to a top of the linkage drive block 128. The stock positioning element 132 is typically a pin beveled so as to engage the plurality of holes 52 in a portion of the supply of reinforcing stock 50 running along the strip feed block 130. The stock positioning element 132 advances the supply of reinforcing stock 50 through the module 118 as the linkage drive block 128 is pushed forward by the piston rod 126.

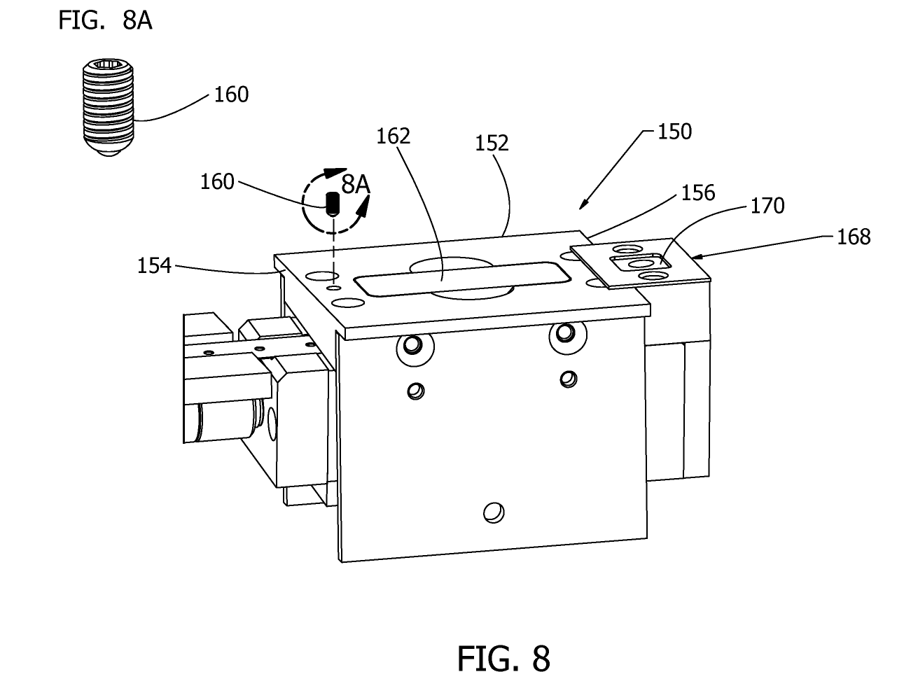

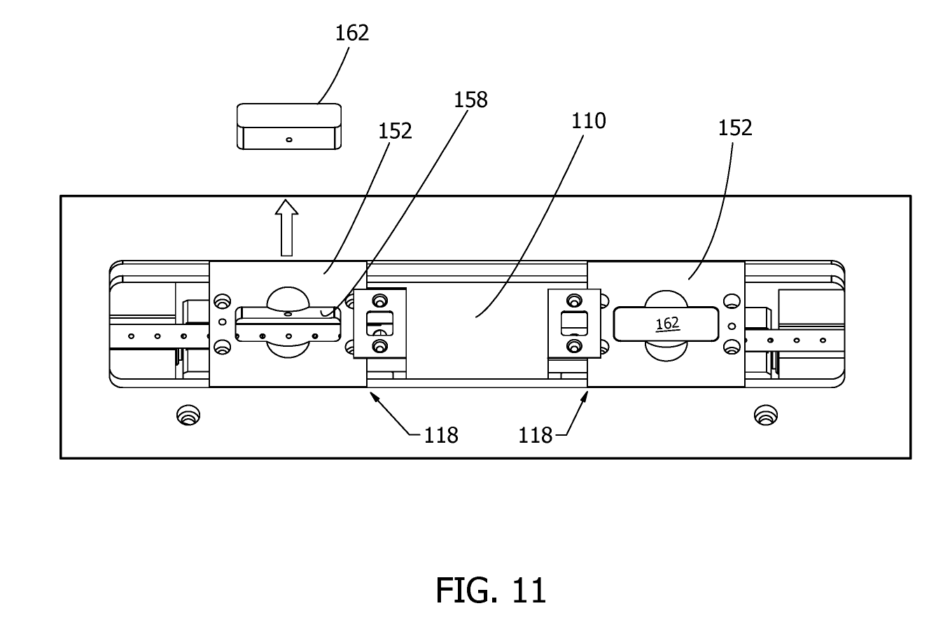

As illustrated in FIGS. 8, 8A, and 11 each module 118 further comprises a module cover element 150 comprising a top plate 152 and a detent component 160. The module cover element 150 is positioned within the centrally disposed opening 110 of the base plate 104. The top plate 152 comprises a first end 154, a second end 156, and a center slot 158. The second end 156 of the first module 120 is positioned to face the second end 156 of the second module 122 within the centrally disposed opening 110 of the base plate 104. The detent component 160 is typically a ball, cylinder, or similar mechanism that penetrates the top plate 152 near the first end 154 that can align and engage with the plurality of holes 52 in the supply of reinforcing stock 50 to resist or arrest any backward movement of the supply of reinforcing stock 50 as it is advanced through the module 118 by the stock positioning element 132.

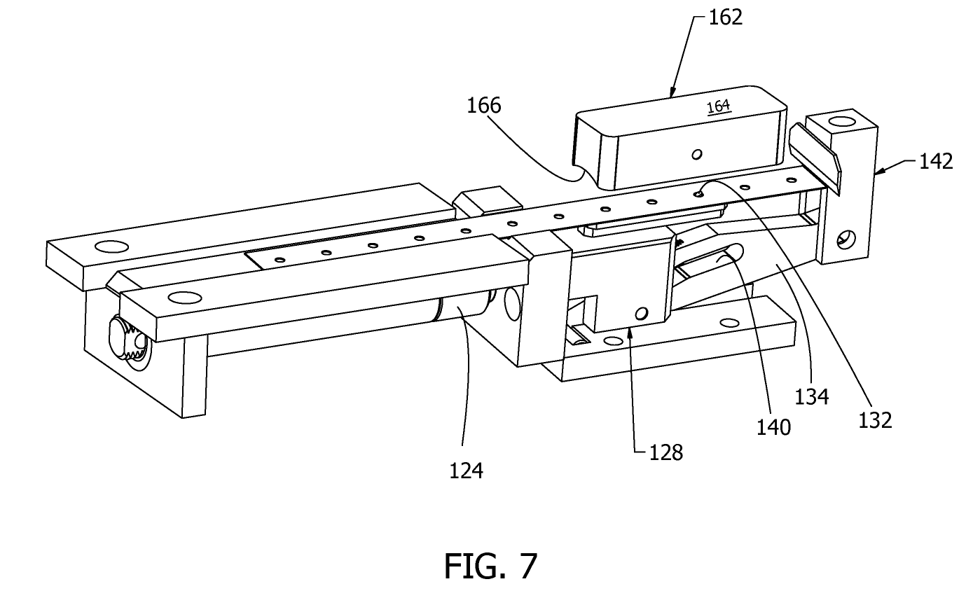

Additionally, each module 118 further comprises a top cover block 162 as illustrated in FIG. 7. The top cover block 162 is positioned within the center slot 158 of the top plate 152. The top cover block 162 is substantially rectangular in configuration comprising a top side 164 and a bottom side 166 crowned or otherwise concavely shaped to permit the stock positioning element 132 to advance the supply of reinforcing stock 50 through the module 118. As such, the bottom side 166 of the top cover block 162 generally abuts the strip feed block 130 sandwiching or otherwise substantially encapsulation the portion of the supply of reinforcing stock 50 engaged by the module 118.

Each module 118 further comprises a top retaining plate 168 and a cutting element 172. The top retaining plate 168 is attached to the second end 156 of the top plate 152 and comprises an opening 170 generally shaped in the same configuration as each of the individual reinforcing elements 60. The cutting block 142 comprises a beveled top 144, a center hole 146, and a bottom 148. The beveled top 144 of the cutting block 142 penetrates the opening 170, thereby pushing the individual reinforcing elements 60 through the opening 170 once cut. The cutting element 172 is typically a stationary knife or blade attached to the second end 156 of the module cover element 150 where it movably abuts the cutting block 142.

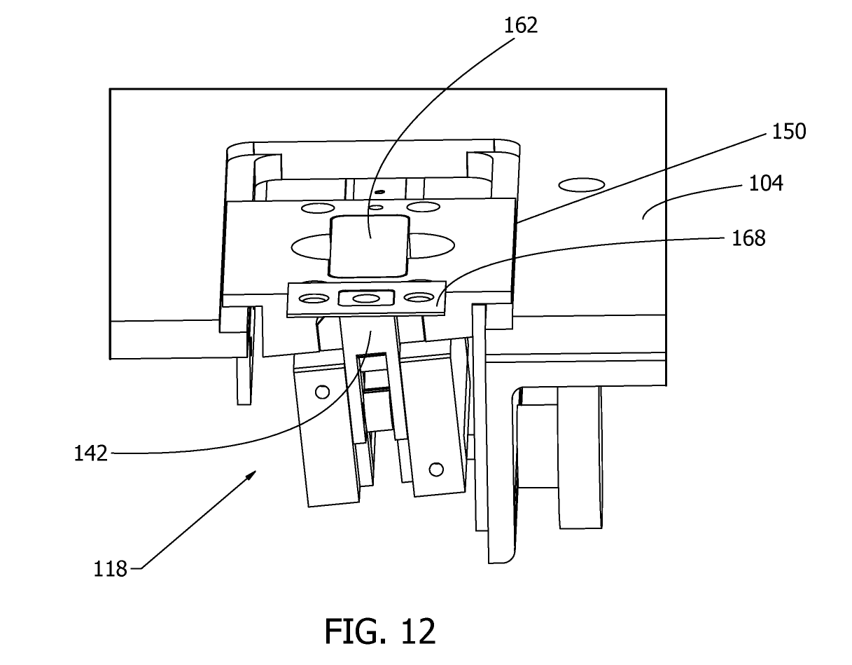

As illustrated in FIG. 12, the beveled top 144 may be angled sideways with respect to the cutting element 172 to more easily cut the individual reinforcing elements 60. In a preferred embodiment, the bevel is approximately set at 5 degrees. However, this is not meant as a limitation as the bevel may be changed to optimize cutting based on the material to be cut or the speed of cutting. The center hole 146 is dimensioned and configured to accept penetration of a needle from the elastic stapling apparatus 30. The bottom 148 movably engages the cam element 134.

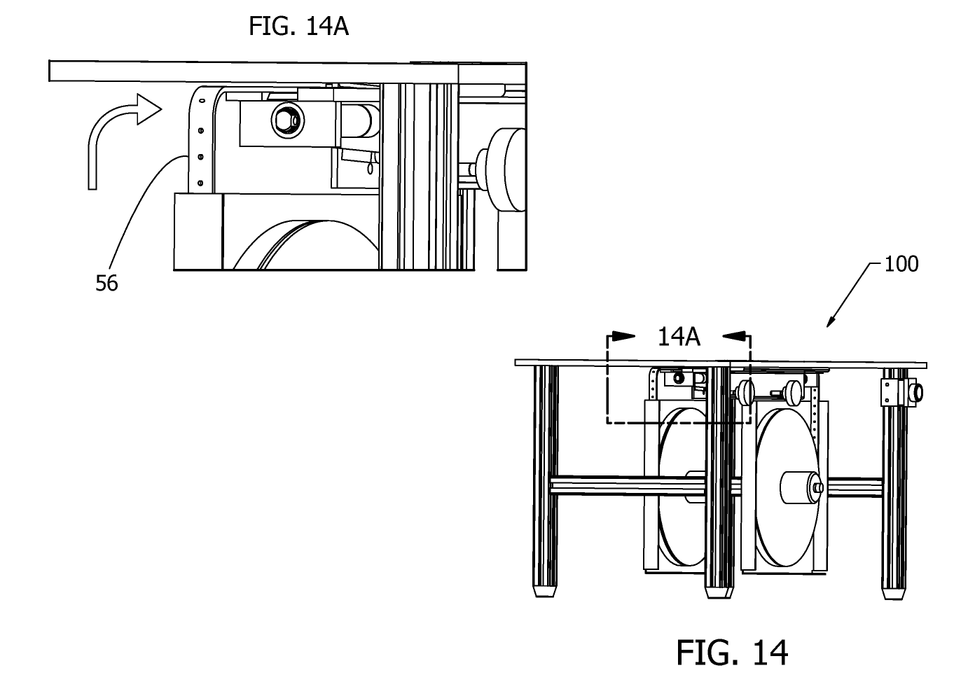

To use the apparatus 100, a user places each of the pair of rolls of the reinforcing stock material 50 onto one of the pair of stock engaging components 112, as illustrated in FIGS. 14 and 14A. A strip the reinforcing stock material 56 from each roll is individually fed into one of pair of modules 118 in opposing directions. Each strip feed block 130 engages one of the strips the reinforcing stock material 56 with the stock positioning element 132. The apparatus 100 may be powered with a motor (not shown).

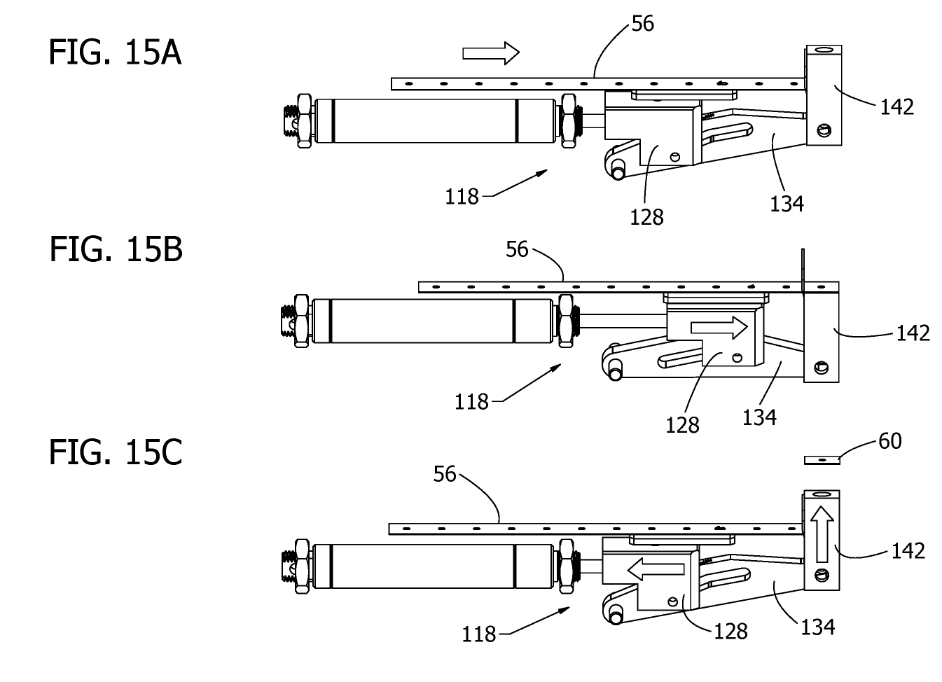

As illustrated in FIG. 15 A, the strip of the reinforcing stock material 56 is positioned on the strip feed block 130 so that an end of the strip the reinforcing stock material 56 abuts the cutting block 142. In a load position, the piston rod 126 is fully retracted holding the linkage drive block 128 away from the cutting block 142. As the apparatus 100 is engaged, the piston rod 126 is extended by the pneumatic element 124 pushing the linkage drive block 128 along the guide slot 140 of the cam element 134 toward the cutting block 142, as illustrated in FIG. 15B. As the linkage drive block 128 moves forward, the cam element 134 pulls the cutting block 142 downward so that the beveled top 144 drops below the level of the cutting element 172. At the same time, the linkage drive block 128 advances the strip feed block 130 so that approximately a ½ inch portion of the supply of reinforcing stock, or any configured length of the plurality of individual reinforcing elements 60 as desired, is pushed past the cutting element 172 and over the cutting block 142.

Finally, in a cutting position illustrated in FIG. 15C, the piston rod 126 is retracted by the pneumatic element 124 pulling the linkage drive block 128 back along the guide slot 140 of the cam element 134 away from the cutting block 142. This retraction allows the cam element 134 to push the cutting block 142 upward against the portion of supply of reinforcing stock located over the beveled top 144. The upward movement forces the beveled top 144 against the supply of reinforcing stock pushing it along the cutting element 172 and through the opening 170 in the top retaining plate 168 to form and detach an individual reinforcing element 60. Simultaneously, the strip feed block 130 returns to its original position as the stock positioning element 132 slips out of the engaged hole 52, and re-engages a distal hole 52 in the supply of reinforcing stock 50 so that the process may repeat. The apparatus 100 may be automatically adjustable to align the plurality of holes 52 of the individual reinforcing elements 60 with the needles of the elastic stapling apparatus 30. As the elastic stapling apparatus 30 is cycled, the apparatus 100 may index the strips of reinforcing material 56 through the next application.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus for manufacturing a plurality of individual reinforcing elements from a supply of reinforcing stock, comprising:
a base plate adapted to support the supply of reinforcing stock;
a pair of modules mounted to the base plate adapted to receive the supply of reinforcing stock, sever the individual reinforcing elements, and deploy the individual reinforcing elements.

2. The apparatus of claim 1, wherein the base plate comprises a centrally disposed opening.

3. The apparatus of claim 2, wherein the pair of modules are adjustable in position along the centrally disposed opening.

4. The apparatus of claim 2, wherein each module comprises a pneumatic element, a linkage drive block engaged by the pneumatic element, a cutting block, and a cam element movably connecting the linkage drive block and the cutting block.

5. The apparatus of claim 4, wherein each module further comprises a strip feed block attached to the linkage drive block.

6. The apparatus of claim 5, wherein the strip feed block comprises a stock positioning element for engaging and advancing the supply of reinforcing stock through the module.

7. The apparatus of claim 6, wherein each module further comprises a top cover block abutting the strip feed block to substantially encapsulate a portion of the supply of reinforcing stock engaged by the module.

8. The apparatus of claim 4, wherein each module further comprises a module cover element located within the centrally disposed opening of the base plate.

9. The apparatus of claim 8, wherein the module cover element comprises a detent component for engaging and resisting backward movement of the supply of reinforcing stock through the module.

10. The apparatus of claim 9, wherein each module further comprises a cutting element abutting the cutting block.

11. The apparatus of claim 10, wherein the supply of reinforcing stock is advanced through each module and over the cutting block when the pneumatic element is extended pushing the linkage drive block forward along a guide slot in the cam element, thereby moving the cutting block downward.

12. The apparatus of claim 11, wherein the pneumatic element is retracted pulling the linkage drive block backward along the guide slot in the cam element, thereby moving the cutting block upward.

13. The apparatus of claim 12, wherein the upward movement of the cutting block pushes the supply of reinforcing stock against the cutting element detaching an individual reinforcing element.

14. An apparatus for manufacturing and dispensing a plurality of individual reinforcing elements from a supply of reinforcing stock for use in conjunction with an elastic stapling apparatus, comprising:
a base plate adapted to support the elastic stapling apparatus and the supply of reinforcing stock;
a pair of modules movably mounted to the base plate to align with the elastic stapling apparatus and adapted to receive the supply of reinforcing stock, sever the individual reinforcing elements, and deploy the individual reinforcing elements; and
wherein the supply of reinforcing stock comprises a pair of rolls of reinforcing stock material.

15. The apparatus of claim 14, wherein each module comprises a pneumatic element, a linkage drive block engaged by the pneumatic element, a cutting block, a strip feed block attached to the linkage drive, and a cam element movably connecting the linkage drive block and the cutting block.

16. The apparatus of claim 15, wherein each module further comprises a module cover element located within a centrally disposed opening in the base plate.

17. The apparatus of claim 15, wherein the cutting block comprises a beveled top and a hole for accepting a needle of the elastic stapling apparatus.

18. The apparatus of claim 14, wherein the pair of modules are oppositely aligned along a centrally disposed opening in the base plate.

19. The apparatus of claim 14, wherein each of the pair of rolls of reinforcing stock material are individually fed into one of the pair of modules in opposing directions.

20. An apparatus for reinforcing a plurality of stapling connections for use in conjunction with an elastic stapling apparatus, comprising:
a base plate adapted to support the elastic stapling apparatus and a pair of rolls of reinforcing stock material;
a pair of modules movably mounted to the base plate in opposing directions, each module adapted to receive one of the rolls of reinforcing stock material, sever the rolls of reinforcing stock material into a plurality of individual reinforcing elements, and deploy the individual reinforcing elements to reinforce the stapling connections; and
wherein each module comprises a pneumatic element, a linkage drive block engaged by the pneumatic element, a cutting block, a strip feed block attached to the linkage drive, and a cam element movably connecting the linkage drive block and the cutting block.
